(19) United States
(12) Patent Application Publication
(10) Pub. No.: US 2013/0331998 A1
(43) Pub. Date: Dec. 12, 2013

(54) MODULAR MANAGEMENT SYSTEM FOR POWER, WATER AND GAS COLLECTION, MEASUREMENT AND CONTROL

(71) Applicants: Paulo Ricardo Pereira Ferreira, Rio de Janeiro (BR); Joao Machado Magalhaes De Alme, Rio de Janeiro (BR)

(72) Inventors: Paulo Ricardo Pereira Ferreira, Rio de Janeiro (BR); Joao Machado Magalhaes De Alme, Rio de Janeiro (BR)

(21) Appl. No.: 14/000,359

(22) PCT Filed: Feb. 17, 2012
(86) PCT No.: PCT/BR2012/000032

§ 371 Date: Aug. 19, 2013

(30) Foreign Application Priority Data
Feb. 18, 2011 (BR) PI1 100227-1
Feb. 14, 2012 (BR) BR 102012003313 5

(51) Int. Cl. G05B 13/02

(52) U.S. Cl. CPC G05B 13/02
USPC 700/286

(57) ABSTRACT

Modular management system for power, water and gas collection, measurement and control includes a MUNC equipment having electrical and electronic circuits, with resident control program, electronic meters and a first module, the first module includes control, processing and power supply circuits, at least one battery to ensure uninterrupted operation, a microprocessor, memory for resident program and through the communication modem and a second module including control and processing circuits, communication modem and ports, with the equipment being able to perform data collection and processing from power, water, gas or liquid fuel meters.

### RELATED APPLICATIONS

The present application is a National Phase of International Application Number PCT/BR2012/000032, filed Feb. 17, 2012, and claims priority from Brazil Application Number PI1 100227-1, filed Feb. 18, 2011 and Brazil Application Number BR 10 2012 003313 5, filed Feb. 14, 2012.

### TECHNICAL SECTOR

The construction principles and functionalities found in the present invention are applicable to the distribution sector of power, gas, water, liquid fuels, industrial and building automation and lighting systems; particularly with regard to monitoring systems and processing of information concerning the distribution of power, gas, water, liquid fuel and lighting systems.

### OBJECTIVE OF THE INVENTION

The present invention is a system for collecting and monitoring information and parameters obtained by power, gas, water and fuel distribution meters.

In addition, it is a system for collecting and monitoring information and parameters obtained by conventional bulb electronic ballasts power supplies, and AC/DC converters to LED bulbs.

It is an objective of the present invention to provide a system for processing information received from power, gas, water and liquid fuels distribution meters.

It is a further objective of the present invention to provide a system for processing information received from conventional bulb electronic ballasts, power supplies, and AC/DC converters to LED bulbs.

### DESCRIPTION OF THE FIGURES

FIG. 1: Describes elements that comprise the MUNC (1);

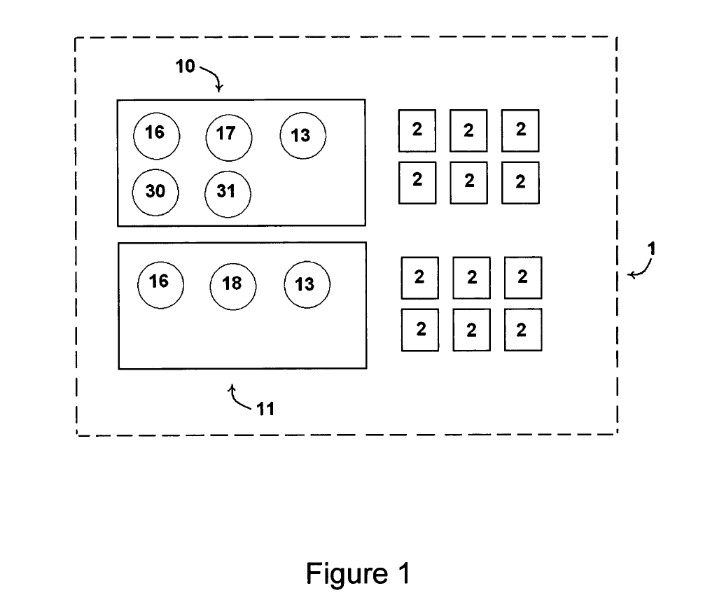

FIG. 2: Describes elements that comprise the CONCENTRATOR (40);

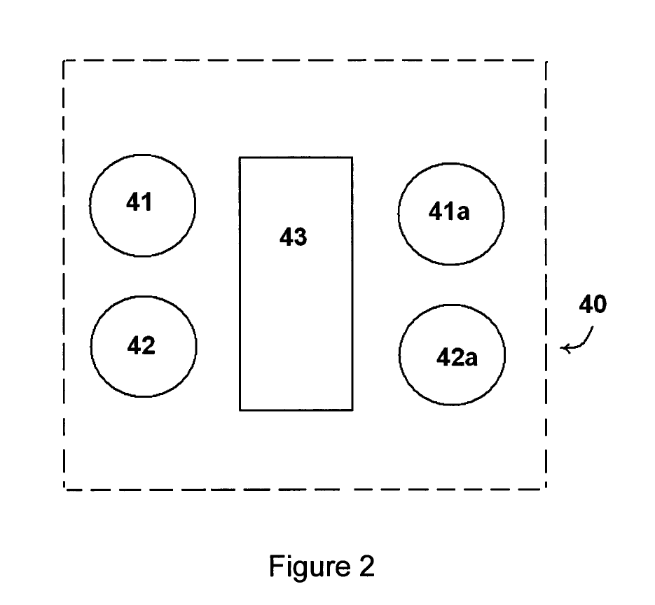

FIG. 3: Describes elements that comprise the MCLC (20);

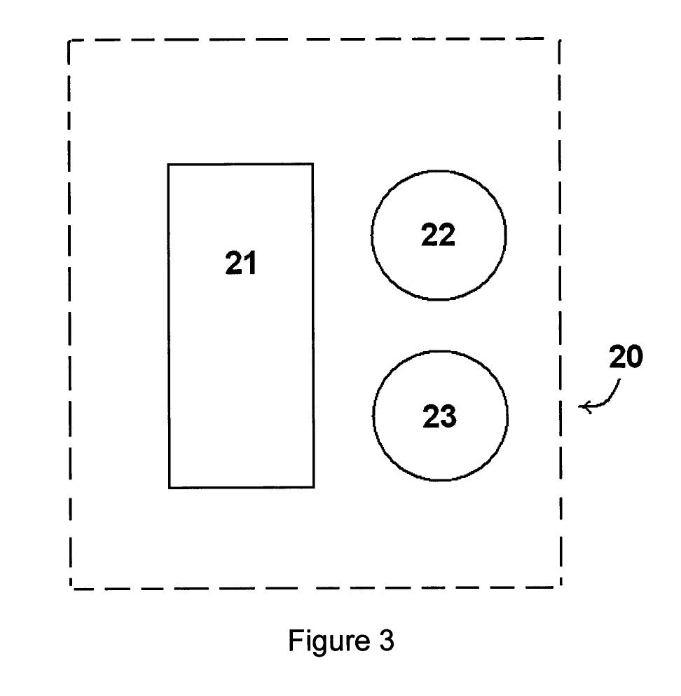

FIG. 4: Describes elements that comprise the enclosure (30) and the MUNC (1).

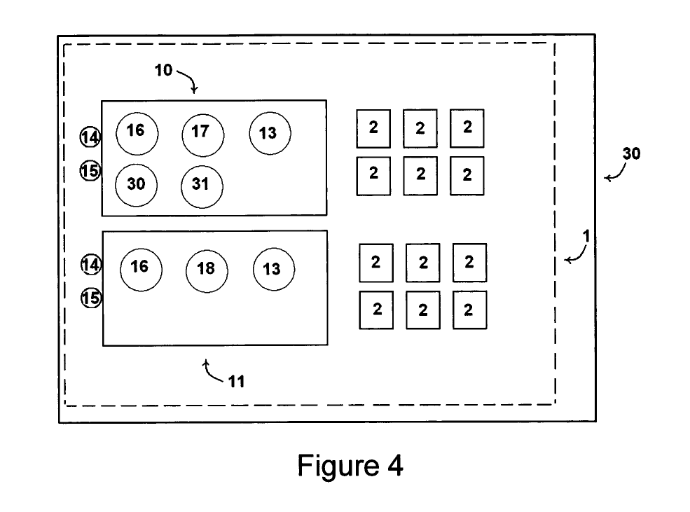

### DETAILED DESCRIPTION OF THE INVENTION

The present invention is a system composed of the elements detailed below:

An equipment composed of electrical and electronic circuits, with resident and modular control program called Universal Module of Measurement Collection or the Portuguese acronym MUNC (1), whose main function is the automatic measurement collection, and the MUNC (1) including meters or ballasts, power supply and AC/DC converters for electronic LED bulbs (2) from any manufacturer, of measurement and/or electric power supply management able to communicate through a communication port all data related to the measuring and pricing process in its internal register, as well as for ballasts, power supplies and converters to provide all data on the lighting consumption and management provided by the bulb connected to it.

The connection of meters, ballasts and converters with either optical or serial communication port (RS-485 or RS-232) can be based on the ABNT NBR 14522 standard or any standard known or provided by the meter or ballast manufacturer. In the case of reactors the DALI protocol will be supported.

The resident program of this device, capable of identifying in a plug-and-play manner the meter features and remotely send them to automatic identification in the WEB-based system to be described below, provides any information that identifies its manufacturer and model via its protocol; or electronic or electromechanical power meters, from any manufacturer, equipped with pulsed output for its measurement calculation; or fluid meters, for water or fuel, from any manufacturer and with any metrological specification, with pulsed output for its measurement calculation; or gas meters, from any manufacturer and with any metrological specification, with pulsed output for its measurement calculation.

Furthermore, the MUNC (1) may have the ability to receive through remote data communication, from a WEB-based system (described below), shut-off and reconnection commands for power, water, or gas supply, by activating the controllers, such as two-state pulsed relays (for power, ballasts and converters), solenoid valves or rotating pulse valves (for gas or water systems and fluid measuring systems).

For power supply reconnection, this will only be allowed if there is no voltage in the client side of the relay, which will be connected to the power meter output for the customer's premises for which he is responsible.

The MUNC (1) further comprises two sub-modules: the first module (10) composed of control, processing, GPS positioning, and power supply circuits (16) with at least one battery (17) to ensure uninterrupted operation, a microprocessor (30), memory (31) for resident program and through communication modem (13), which can be a mobile (quad-band), RF, 902-928 MHz, Wi-Max, Wi-Fi, PLC—Power Line Communications—RS-232 or RS-485 cables and with up to 50 ports (RS 232 or RS-485 pulsed or serial) for connecting power, gas or water meters, and 50 ports for controlling the activation of pulsed relays (for power) or solenoid valves (for water and gas) or rotating pulse valves (for water and gas); the second module (11) includes control and processing circuits (16), communication modem (13), additional ports (18) (RS-232 or RS-485 pulsed or serial) for connection of power, gas or water meters, for example, the second module (11) includes six ports (18), in addition to 100 extra ports for controlling the activation of pulsed relays (for power) or solenoid valves (for water and gas) or rotating pulse valves (for water and gas).

According to this implementation, the module (11) can work with up to 12 power meters, from any manufacturer with protocol communication, or up to 12 power meters, from any manufacturer with pulsed ports, or up to 12 water and gas pulsed meters. The Module (11) may present the connection simultaneity for the water, gas and power meters, provided that all of them are provided with pulsed port to inform its measurement, preserving a maximum of 100 connections with meters per MUNC.

It is worth to point out that the system can be configured to operate with up to 100 power meters (2). In this configuration, the system is better dimensioned for the measurement and control of building electrical installations and power distribution. It is also important to note that a power distribution expert can resize the system according to the principles presented herein. In order to set it to measure and control the distribution systems of different building architectures, including other numbers of meters that were merely exemplified here.

Depending on the type of the meter to be controlled by the MUNC (1), the plate (12) responsible for such communication must be compatible so that we can observe the communicability required from the following examples as described below: protocol controller for power meters with protocol output, communication controller per pulse for pulsed power meters or water and gas meters with pulsed outputs.

Likewise, depending on the type of communication between them, the CONCENTRATOR (40), the communications plate (12) that hosts the communication modem (13) between the MUNC (1) and the WEB-based system may also be modified to result the required communicability. This modem can be:

Cellular—In order to support GPRS, EDGE and WCDMAJHSDPA modems, for example. GPRS has a maximum rate from 26 to 40 Kbps. This technology is part of the 2.5G mobiles. The EDGE is a 2.5G technology evolution and therefore can be considered part from the 3G family. And in practice its speed can reach 384 Kbps. These two technologies operate in frequency ranges of 850 MHz to 1900 MHz. WCDMA and HSDPA are the 3G itself. The two networks operate at frequencies up to 2100 MHz with speed peak up to 7.2 Mbps.

RF (radio frequency)—Frequency range from 902 to 928 MHz, for example, with maximum output of 0.04 W, Mirror Technique—Direct Sequence, BSPK Modulation Type, OMNI built-in internal antenna with 2 dBi of reception sensitivity: −114 dBm, maximum output peak intensity: 16 dBm (40 mW), using the DS CDMA standard with ISM frequency range from 902 to 928 MHz with bandwidth of 1.8 MHz; Data speed: 220 Kbps; BPSK modulation with MESH capability. It may operate, for example, in other frequency ranges, such as 434 MHz, 470 MHz and 868 MHz, among others, if necessary.

Wi-Max—For example, operating at frequencies of 2.6 GHz, 3.5 GHz and 5 GHz according to Brazilian standards, reaching speeds of up to 1 Gbps and may be powered by batteries, using a complement circuit that every 15 minutes allows the modem to be enabled for transmission and reception, remaining active until the end of the stored data transmission. With this capability, we noticed that the modem (13) can be used directly from the electric utility, without AC power supply. The modem (13) can also transmit and receive data from other loop modems (other MUNCs) through a capability known by MESH.

Wi-Fi—Able to transmit at frequencies of 2.4 GHz or 5 GHz, for example, and can be powered by batteries, using an additional circuit that every 15 minutes allows the modem to be enabled for transmission and reception, remaining active until the end of the stored data transmission.

With this configuration, the modem (13) can be used directly from the electric utility, without AC power supply. The modem (13) can transmit and receive data from other loop modems (other MUNCs) through the MESH capability. It can make use of IEEE 802.11 networking standards, namely: The 802.11b standard, which transmits in the frequency range of 2.4 GHz of the spectrum radio. The modem (13) is also able to communicate in up to 11 Mbps, using the CCK code—Complimentary Code Keying. Still exemplifying, if the Modem (13) uses the 802.11g standard, it also transmits at 2.4 GHz, but in a much faster way than the 802.11b: it can communicate up to 54 Mbps. The 802.11g standard is faster because it uses Orthogonal Frequency-Division Multiplexing (OFDM), a more efficient coding technique. The 802.11a standard transmits at 5 GHz and can reach 54 Mbps. It also uses the OFDM coding. The 802.11n standard has available transfer rates from 65 Mbps to 600 Mbps.—Transmission method: MIMO (Multiple-Input Multiple Output)—OFDM-Frequency Range: 2.4 GHz and/or 5 GHz.

The PLC or Power Line Communications supports PLC modems from any manufacturer, either for “indoor” or “outdoor” use.

The RS-485 or RS-232 Cable supports “cable modems” from any manufacturer. It is noteworthy that for MUNCs concentration through CONCENTRATORs, the MUNC (1) does not include a Mobile modem, but any other type of modem.

In this configuration, the mobile modem will be one of the CONCENTRATOR modem options. Furthermore, as an enclosure (30) for the meters, the MUNC (1) also controls a temperature sensor (14) and an opening sensor (15) for the box lid and to detect foreign matters inside it. These sensors are controlled directly by the resident program (P) in the MUNC Microprocessor Unit (1). The temperature sensor can be parameterized. In its parameterization, it allows to register a maximum room temperature which, once reached, causes the MUNC resident program to activate a high-temperature alarm. The alarm is sent to the WEB-based system. A second registered temperature determines the point at which the MUNC (1) will immediately command all meters that it controls in the first module (10), and in the second module (11) to shut off, and sends an alarm when the measuring assembly is at risk of fire. At least one port or presence sensor (16) is used to secure the meter assembly (2) from an attempt of opening the enclosure (30) where the meter assembly (2) and the MUNC (1) are installed so as to prevent their unauthorized and undue handling (2). In the event of an unauthorized opening, the MUNC (1) immediately commands the shutting off for all meters and sends an alarm of unauthorized handling or opening of the enclosure (30) of the meters (2) to the WEB-based system.

For the MUNC (1) or the Meters (2) maintenance housed inside the enclosure (30), the MCLC Module, detailed below, has in its resident program the option of disabling the port or presence sensor, so as to allow the maintenance of the assembly without affecting the consumers interconnected to it. After disabling the port or presence sensor, the MUNC sends to the WEB-based system the time when it was disabled, and at the maintenance end, after its rehabilitation by the “Configuration Module and Field Reading” (or MCLC) (20), the system sends a new alarm to the WEB-based system with the time when it was re-activated to allow the calculation of the maintenance time for each assembly. The MUNC (1) can be installed internally in enclosures for power meters protection of any type and made of any material (metal, plastic injection molded resin, wood, etc.), including boxes with lenses by CPREDE (in all its models and constructed with any material—metal or any plastic resin or injected into molds, etc.), for installation on street lamps and extension of the meters display view in order to allow its installation at any height greater than 2 meters above the ground.

The scope of the present invention consists of an electronic device responsible for the concentration to 10,000 meters (for power, water, gas or liquid fuels) connected to remote MUNC units (1) called CONCENTRATOR (40). This CONCENTRATOR (40) is responsible for sending the information collected to the WEB-based system, which can be done by a mobile communication or local network interface connected to a broadband router or a Wi-Fi public network device provided with a fixed IP for Internet access.

The CONCENTRATOR (40) receives the MUNCs data through a modem identical (41) to that installed in the MUNCs which are on the same measurement network of the CONCENTRATOR (40), i.e. in case the CONCENTRATOR (40) is the point of concentration of a set of MUNCs installed with RF MODEMS, the CONCENTRATOR (40) will have a RF MODEM to receive data and send commands to shut off and reconnect, whichever is controlled from the WEB-based system. The same concept applies to other types of supported modems, as above. The CONCENTRATOR (40) can communicate with up to 10.000 MUNC units (1). The CONCENTRATOR (40) further includes antennas (42) to optimize the Modem reception (41), a data processing unit (43) with RAM and ROM memories, and a resident program for the information processing required, and a modem (41a) and an antenna (42a) to send shut-off and reconnection commands.

When using MUNCs with Wi-Fi or Wi-Max Modems, the CONCENTRATORs (40) will be replaced by standard Hot Spots, Access Points or Routers, from any manufacturer that supports this technology and provided with MESH capability for a MCLC (20). The MCLC (20) further includes a program to configure the MUNC communication plate (1), with the following capabilities: update the resident program for interpreting communication protocols between the MUNC (1) and the electronic power meters (2); and define the pulse constant on the MUNC communication plate (1) which collects the pulses of power meters, liquid fuel, gas or water.

In addition, the MCLC (20) has the ability to collect all the readings performed by the MUNCs in its operating range. The MCLC (20) will operate with an external communication modem similar to the MUNCs with which it must communicate. Through synchronization with computers, the MCLC resident program (20) can transfer its database of readings performed in field directly to the WEB-based system. If the CONCENTRATORs are not used, this ability allows the readings of the meters connected to MUNCs to be collected by itinerant readers or by readers in cars and updated in the system. Thus, the MCLC includes a processing unit (21), such as a portable personal computer if there is any operating system compatible with the resident program, a modem (22) and an antenna (23).

An application system (50), called NG AMRTEC developed in WEB platform in HTML, ASP and JAVA language, using data storage in Microsoft SQL Server Bank, which can be run on any operating system platform for WEB servers.

The application (50) consists of a set of programs in WEB platform capable of receiving measurement data collected by remote communication from power, water or gas meters, provided with two-way communication and enabling the registration of alarms related to the control of fraud attempts and consumption levels of each customer outside the profile, in addition to enable the shut-off and reconnection commands remotely.

This information system platform also allows the visualization of charts on the consumption curves for each customer, the main quantities reported by remote meters, and presents comparative data of the consumption curves between customers and of a same customer considering different time periods.

This information system platform also allows the creation of Leak Groups, in which various levels of the main water or gas meters are registered, and whose measurement shall be equal to the sum of the measurement of the subsequent level meters, with tolerance to small percentage variations, which are configurable in order to preserve the normal losses related to the distribution network that interconnects them.

This information system platform also enables the creation of Energy Balancing Groups, in which various levels of the main power meters are registered, and whose measurement shall be equal to the sum of the measurement of the subsequent level meters, with tolerance to small percentage variations, which are configurable in order to preserve the normal losses related to the distribution network that interconnects them (e.g. losses by Joule effect).

1-10. (canceled)

11. Modular management system for power, water and gas collection, measurement and control comprising a single platform capable of transporting all data gathering measurement information collected from energy meters, water, gas, electronic ballasts (bulbs), LED lamp drivers, and other equipment that have an communication protocol known in order to create a communication network complete and fully comprehensive and, including a MUNC equipment composed of electrical and electronic circuits, with resident control program, electronic meters and a first module, the first module includes control, processing, power supply circuits, at least one battery to ensure uninterrupted operation, a microprocessor, memory for resident program and through the communication modem and a second module including control and processing circuits, communication modem and ports, with the equipment being able to perform data collection and processing from power, water, gas or liquid fuel meters.

12. A system according to claim 11, including ballasts or power supplies and AC/DC converters for LED bulbs instead of electronic meters.

13. A system according to claim 11, including a communication modem suitable for protocols communication with electronic power meters and communication modem able to communicate by pulses.

14. A system according to a claim 11, including a concentrator, and the concentrator including antennas to optimize the Modem reception, a data processing unit with RAM and ROM memories and a resident program to process the information required, and a modem and an antenna to send shut-off and reconnection commands.

15. A system according to claim 11, including a concentrator, and the concentrator including antennas to optimize the Modem reception, a data processing unit with RAM and ROM memories and a resident program to process the information required, and a modem and an antenna to send shut-off and reconnection commands.

16. A system according to claim 11, including a MCLC (20), and the MCLC including a processing unit, a modem and an antenna.

17. A system according to claim 11, allowing the visualization of charts related to curves of consumption of each customer and the main quantities informed by the remote meters, in addition to present comparative data of consumption curves between customers and for a same customer, considering different periods of time through the application system.

18. A system according to claim 11, allowing the creation of leak groups, in which various levels of the main water and gas meters are registered, and whose measurement should be equal to the sum of the measurement of subsequent level meters, with tolerance to small percentage changes, which are configurable in order to preserve the normal losses related to the distribution system that connects them through the application system.

19. A system according to claim 11, allowing the creation of Energy Balancing Groups, which are registered in the various levels of primary power meters, and whose measurement should be equal to the sum of the subsequent level meters, with tolerance to small percentage changes, which are configurable in order to preserve the normal losses related to the distribution system that connects them through the application system.

20. An enclosure housing the MUNC equipment, at least one temperature sensor and at least one opening sensor, in which the temperature sensors and the opening sensor are controlled by the MUNC equipment.

21. An enclosure according to claim 18, including an optical system that facilitates reading the instruments remotely.
